(19) United States
(12) Patent Application Publication
(10) Pub. No.: US 2026/0100043 A1
(43) Pub. Date: Apr. 9, 2026

(54) ANTI-THEFT SYSTEM PRIOR TO REACHING A POINT OF SALE SYSTEM

(71) Applicant: TOSHIBA GLOBAL COMMERCE SOLUTIONS, INC., Durham, NC (US)

(72) Inventor: Morgan DWYER, Durham, NC (US)

(73) Assignee: TOSHIBA GLOBAL COMMERCE SOLUTIONS, INC., Durham, NC (US)

(21) Appl. No.: 18/905,690

(22) Filed: Oct. 3, 2024

(51) Int. Cl. G06V 20/52; G06V 40/20; G08B 13/24; G06K 7/14

(52) U.S. Cl. CPC G06V 20/52; G06V 40/20; G08B 13/2462; G06K 7/1443

(57) ABSTRACT

Systems and methods for providing store intelligence. The methods involve: receiving, from the camera, image data of a person selecting the article and receiving, from a reader, tag data associated with the article; determining that a potential theft event has occurred using both the tag data and the image data while the item is in the selling area of the store but before the item is proximate to a checkout area of the store; selectively performing first operations facilitating facility security in response to determining that the article and tag is currently being manipulated in an abnormal manner.

### BACKGROUND

Theft in retail stores is an issue that retail stores want to prevent. Electronic article surveillance (“EAS”) systems can employ security tags to protect retail items from theft. These security tags may be passive, and therefore may be capable of only a limited one-way transfer of information. Some security tags have a self-alarming feature. In this case, an alarm of the security tag is issued in response to a defeat thereof or upon movement of the security tag into a detection field of an EAS system. However, there are various ways to defeat this alarm and other ways to steal items in a store.

### BRIEF DESCRIPTION OF THE DRAWINGS

The objects and features of the present disclosure can be better understood with reference to the drawings described below, and the claims. The drawings are not necessarily to scale, emphasis instead generally being placed upon illustrating the principles of embodiments of the present disclosure. In the drawings, like numerals are used to indicate like parts throughout the various views.

FIG. 1 illustrates a diagram of components in a store with a selling area and a checkout area where the store employs the theft prevention system in accordance with some embodiments.

FIG. 2A illustrates block diagram of an exemplary architecture for a reader shown in FIG. 1. in accordance with some embodiments.

FIG. 2B illustrates block diagram of an exemplary architecture for a camera shown in FIG. 1. in accordance with some embodiments.

FIG. 3 illustrates block diagram of an exemplary architecture for the theft prevention system shown in FIG. 1 in accordance with some embodiments.

FIG. 4 illustrates a flow diagram of an exemplary method for providing store intelligence for a theft prevention system in accordance with some embodiments.

### DETAILED DESCRIPTION OF THE EMBODIMENTS

Generally, the present disclosure provides a system for proactive theft prevention prior to the user getting to a checkout area in the store. This can be done using both security camera feeds and RFID tracking. Moreover, models may be employed that learn the criminal behavior that precedes theft, and the present disclosure contemplates using that learning to predict when a theft is about to occur, at which time store personnel can be alerted via various ways, such as via mobile devices.

The present disclosure concerns implementing systems and methods for providing facility intelligence to detect, deter and/or prevent theft before it actually happens, and especially before the potential thief gets to the checkout area or the exit of the store. The methods comprise using tags and cameras in a selling area of a store where items can be selected. Each of the data relating to the tags and data relating to cameras are discussed separately in a general manner below.

Referring first to the data originating from the tag, the method includes receiving tag data which includes movement of a security tag on an article or object. Sensor data from a tag may also be received which may relate to changes in geographic position of the tag, changes in light conditions of a surrounding environment, changes in a temperature of the surrounding environment, changes in an amount of fluid in a surrounding environment, or changes in a magnetic field strength generated by the security tag.

The tag and/or sensor data is then analyzed by an electronic device remotely located from the security tag. This analysis is performed to determine if the security tag is currently being moved. If so, a determination may also be made as to whether or not the security tag's movement is normal or abnormal. If a determination is made that the security tag is currently being moved in an abnormal manner, then the electronic device performs first operations that facilitate facility security. For example, the security tag's alarm is issued, an image is captured of a person in possession of the security tag, store personnel is notified of the security tag's abnormal movement, or the store personnel is dispatched to a location within a facility at which the security tag resides.

Moreover, this tag/sensor data may be combined with camera image data of the user as mentioned above. In this regard, cameras supplement the intelligence received by the tag data to verify that the user is performing a potentially criminal act in the store, as well be discussed in more detail later herein.

If a determination is made that the security tag is not being moved in an abnormal manner, then movements of the user may be continually monitored by the cameras located throughout the store. Alternatively, the cameras may be activated in response to the tag data indicating an article has been selected/moved.

Additionally, the tag data is analyzed to determine: if the security tag is being concealed, shielded or placed in a metal lined bag; if the security tag is located in or traveling towards a high risk location of a facility; and/or if an attempt is being made to defeat the security tag. If a determination is made that the security tag is being concealed, shielded or placed in a metal lined bag, then the electronic device performs certain predefined operations facilitating facility security. The operations comprise issuing an alarm of the security tag and/or notifying store personnel of the security tag's concealment, shielding or detuning. If a determination is made that the security tag is located in or traveling towards a high-risk location of a facility, then the electronic device selectively performs the operations facilitating facility security. If a determination is made that an attempt is being made to defeat the security tag, then electronic device selectively performs the operations facilitating facility security.

Various examples and more details of the present disclosure will now be described below. The following description provides specific details for a thorough understanding and enabling description of these examples. One skilled in the art will understand, however, that the present disclosure may be practiced without many of these details. Additionally, some well-known structures or functions may not be shown or described in detail, so as to avoid unnecessarily obscuring the relevant description.

The terminology used in the description presented below is intended to be interpreted in its broadest reasonable manner, even though it is being used in conjunction with a detailed description of certain specific examples of the present disclosure. Certain terms may even be emphasized below; however, any terminology intended to be interpreted in any restricted manner will be overtly and specifically defined as such in this Detailed Description section.

With reference now to the figures, the present disclosure provides a novel intelligence system for various applications, such as retail applications. The intelligence system employs a camera network, a security tag system and a computing system that all communicate over a network.

In this present disclosure, tag and camera outputs are received and aggregated in order to determine if an article has found its way into a theft circumstance that is predictive in nature. For example, the tag and camera outputs are used to detect: when the security tag and/or article is being handled by a possible thief thereby indicating that an article might be stolen in the near future; when the movements of the customer indicates that the customer will likely try to steal an article; and/or when the security tag is being tampered with thereby indicating that the security tag might be defeated in the near future.

The manner in which such detections are made is described in more depth below. Upon one or more of the above-listed detections certain measures may be taken. For example, if it is determined that the retail item is in the possession of a possible thief, then the security tag's alarm can be issued and/or the requisite store personnel can be informed and/or dispatched to intercept the thief. Notably, the present disclosure provides a novel predictive and preventative type of loss prevention technique for business organizations selling, renting, or loaning items to the general public (e.g., retail stores or libraries).

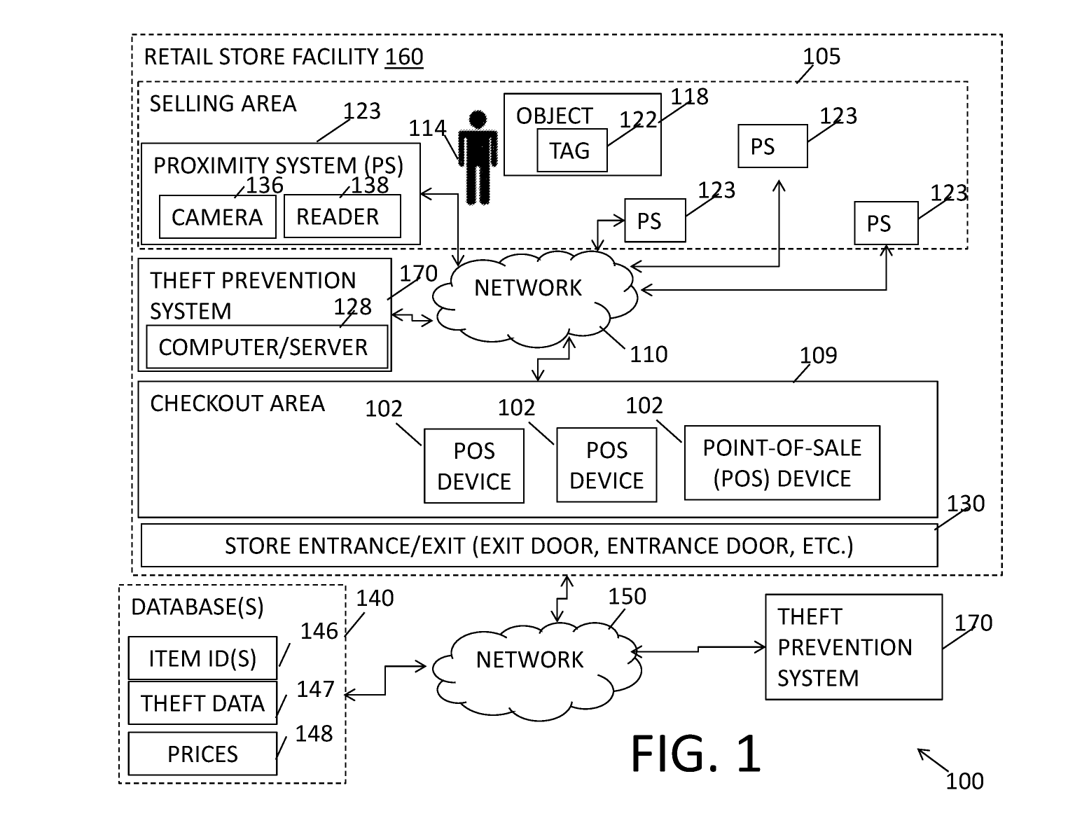

Referring now to FIG. 1, there is provided a schematic illustration of an exemplary system 100. The system 100 is generally configured to allow improved retail store intelligence for theft prevention prior to the theft reaching a checkout area 109 or store exit 130 using technology using imaging and tag data. The tag data can be obtained using communication technology such as radio frequency (“RF”) communication technology.

As shown in FIG. 1, system 100 comprises one or more database(s) 140, a retail store facility (“retail store”, “store” or “RSF”) 160, and/or a theft prevention system 170 which are communicatively coupled to each other via a network (e.g., the Internet) 150.

The retail store 160 includes a selling area 105, a checkout area 109, and entrance/exit 130 as well as a theft prevention system 170 and optionally a local area network 110 of the store.

The selling area 105 is the area of the store where the articles or objects (e.g., food, electronics, clothing, etc.) 118 are being displayed for sale. For example, the articles or objects may be placed on shelves of isles, on racks, or the like in the selling area 105. As shown in FIG. 1, the selling area 105 is separate from the checkout area 109 and is not where the person 114 can checkout or potentially buy the item. In this regard, FIG. 1 is an illustration showing the physical layout of the store with the selling area 105 being separated from the checkout area 109 by a predetermined distance (e.g., 10 feet, 50 feet, 100 feet, etc.).

The checkout area 109 of the store 160 includes one or more point-of-sale (“POS”) devices 102 configured to allow the user to buy any of the objects 118 for sale in the store. This checkout area 109 is typically next to the store entrance/exit 130 but is not required to be. As mentioned above, the checkout area 109 is separate from and may be remote from the selling area 105 in the store 160. The beginning of the checkout area 109 is at least a predefined distance from an end of the selling area, such as 20 feet, 30 feet, 40 feet, or the like.

The database 140 includes various data items that the POS devices in the checkout area 109 can query including item IDs 146 and prices 148 of the items for use in checking out with the POS devices 102. The database 140 may also include theft data 147 such as movement and/or tag data indicative of theft for use with the theft prevention system 140 as is discussed herein. The database 140 may include additional items including the unique IDs of the tags 122 or any other data for use in the systems 170 and POS 102. These items 146, 147, 148 in the database 140 can be created and updated regularly via a central computer system (not shown).

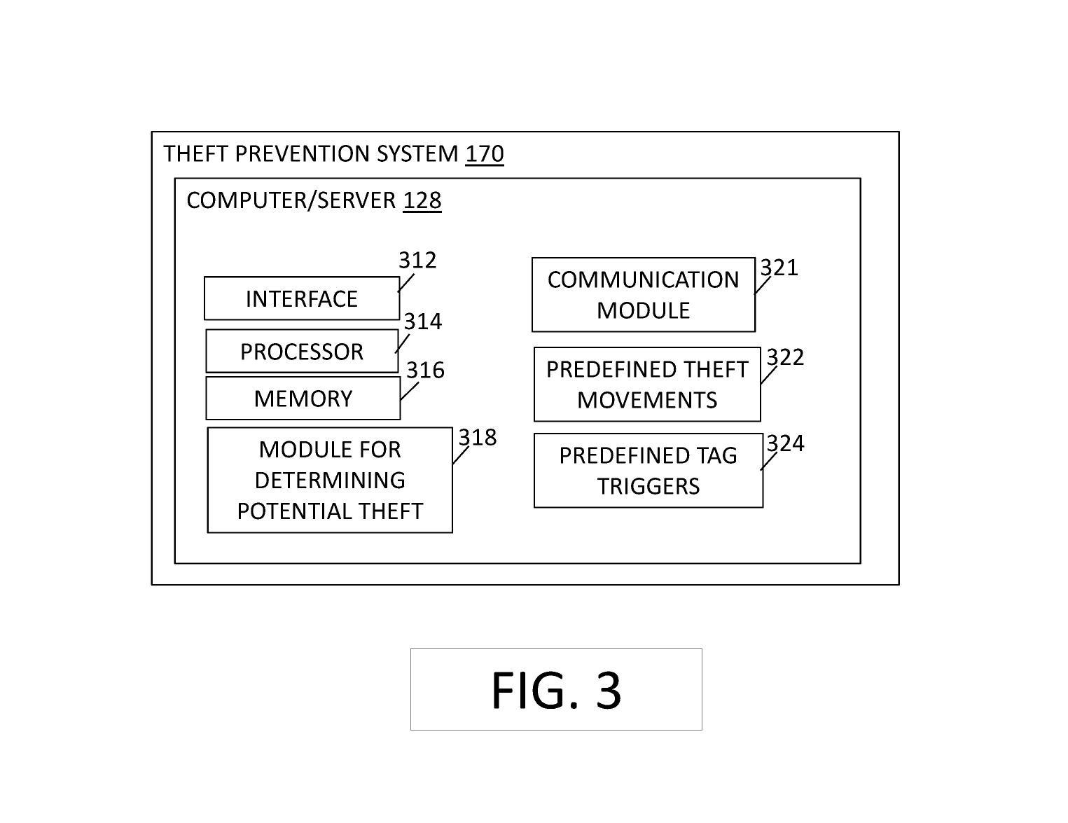

The theft prevention system 170 is a system for collecting data (both tag and image data), analyzing the data and determining whether a potential theft event is occurring or not. The theft prevention system 170 includes a computer/server 128 which is configured to perform the operations disclosed herein. The computer/server 128 is discussed in more depth with regard to FIG. 3.

Although FIG. 1 is shown as having the theft prevention system 170 internal to the retail store facility 160 and external to the retail store facility 160, the present disclosure is not limited in this regard. For example, the theft prevention system 170 can reside in the different building or geographic area than the store 160 and thus, does not need to be on the same network 110 as the store. Alternatively, the theft prevention system 170 can be the same part of the retail store facility and/or be on the same network as the store’s network 110. In some embodiments, the theft prevention system 170 can be the same part of the retail store facility 160 and also remote from the retail store facility 160 via network 150.

The store 160 is generally configured to provide enhanced store security, store intelligence and customer service. In this regard, the store 160 comprises a network 110 defined by a plurality of proximity systems (“PS”) 123 disposed at various strategic locations therein. For example, a first proximity system 123 is coupled to an isle, shelves, floor space, etc. in the selling area 105 where articles or objects for sale are located. A second proximity system 106 is disposed on or in another area that is remote from the checkout area 109. In one embodiment, a third proximity system 123 may be disposed on at least one pedestal located at an exit/entry point 130 of the RSF 160. A fourth proximity system 123 is disposed in a fitting room (not shown). In another embodiment, a fifth proximity system 123 is disposed in at the checkout area. Additional proximity systems 123 may be disposed in any high-risk locations within the store 160 (e.g., a bathroom) and any other area where there is no coverage from any other PS 123. In this regard, all areas of the RSF 160 may be covered by the PS systems 123.

Each proximity system 123 comprises a reader 130 and/or a camera 132. The reader 130 is generally operative to communicate information to and/or from the security tags 122 coupled to objects/articles 118 (e.g., merchandise) and/or other communication devices via short range technology (e.g., Bluetooth, RF technology, etc.). The other communication devices can include, but are not limited to one or more computer/server devices 128 within the theft prevention system 170 of the store 160, and the like. The computing device/server 128 may act as the theft prevention system (also referred to herein as a store intelligence system (“SIS”)).

In some scenarios, the reader 130 may be an RFID reader which outputs a constant beacon within a predetermined area around the reader. It should be understood that the reader 130 can be used as a transmit device and/or as a receive device using RF technology.

The camera 132 is used to real-time monitor of actions of people entering, present within, and/or exiting the store 160 to assist in determining the movement of the people in the RSF 160. The present disclosure is not limited to cameras as devices for obtaining information relating to the movement of people in and around the store.

The information communicated from the reader 130 to the theft prevention system 170 can include, but is not limited to, a unique identifier of the tag 122 as well as the unique identifier of the reader 130. The unique identifier of the reader 130 provides a means to determine the location of a person 114 and/or a security tag 122 within the store 160. The tag-related information can be used to track movement of the security tag 122 within the store 160, track the number of customers interested in and/or actually purchased a retail item, determine if the security tag has been deactivated and/or detached from an article 118, determine if security measures need to be performed in relation to a particular customer, and inform store personnel of the results of various analytic based operations. The store personnel can be informed in real time or at user-specified times via a communication device (e.g., a mobile phone or handheld equipment) over the network 110.

For example, let's assume that the person 114 is in possession of the article 118 having the security tag 122 attached thereto. In some embodiments, there may be sensors 126 associated with or attached to the tag 122. The sensors 126 of the security tag 122 may obtain sensor data relating to the movement of the security tag, changes in light conditions of an environment surrounding the security tag, changes in the temperature of the surrounding environment, changes in an amount of fluid/liquid of the surrounding environment, and/or changes in a magnetic field generated by the security tag. The sensor data is then sent to the theft prevention system 170 via communication components. At the theft prevention system 170, the sensor data is used for analytic based operations. The analytic based operations are performed in accordance with pre-defined user profiles, user preferences and/or business rules stored in the theft prevention system 170. The user profiles, user preferences and business rules are customizable.

The analytic based operations involve performing at least one of the following operations: determining when a security tag 122 has been deactivated or removed from the attached object 122, determining when a security tag 122 is being moved; track movement of the security tag 122; determine if the movement is normal movement indicating that an article 118 is in the possession of an interested customer or abnormal movement indicating that the article 118 is in the possession of a possible thief; track the location of the security tag 122 in the store 160; determine if the security tag 122 is currently in a high risk location within the store 160 (e.g., exit or fitting room); cause an image to be captured of the person in possession of the security tag 122; and/or provide the requisite store personnel with an indication of the security tag's movement, the type of the security tag's movement, the current location of the security tag 122 in the store 160 and/or the recently captured image of the person in possession of the security tag 122.

Abnormal movement can be detected based on a current orientation of a security tag, a velocity and direction of a security tag's movement (e.g., a relatively fast downward movement of the security tag may indicate a defeat attempt such as slamming the security tag on a hard surface), a pattern of the security tag's movement over a given period of time (e.g., rapid changes in the altitude of the article may indicate that the article is being held by a person running or walking relatively fast), and/or relative altitudes of different portions of the security tag (e.g., an altitude difference of the two ends of a security tag relative to a center portion of the security tag may indicate that a defeat attempt has occurred such as bending the security tag to deform the same). Pre-stored threshold values and/or sensor data patterns (e.g., accelerometer data patterns) can be employed in comparison operations to distinguish between normal movements and abnormal movements.

Additionally or alternatively, the analytic based operations can be performed to: determine if the security tag 122 is being concealed, shielded or placed in a metal lined bag (e.g., a booster bag); cause issuance of the security tag's alarm; and/or notify store personal of the results of the analytic based operations prior to removal of the article from the store 160. The determination can be made based on sensor data from a light sensor indicating changes in ambient light in a surrounding environment over a given period of time and/or sensor data indicating that the security tag has been detuned.

The analytic based operations may also be performed to: detect changes in an amount of fluid/liquid surrounding the security tag; detect changes in an ambient temperature of a surrounding environment over a given period of time; cause issuance of the security tag's alarm; and/or notify store personal of the results of the analytic based operations prior to removal of the article from the store 160. Changes in an amount of fluid/liquid contained in a surrounding environment may indicate an occurrence of a defeat attempt by the submission of all or a portion of a security tag in a fluid/liquid. Changes in an ambient temperature may indicate an occurrence of a defeat attempt by melting a security tag using a lighter or other heating apparatus.

Although the theft prevention system 170 is shown in FIG. 1 as residing in both the store 160 and remote from the store 160 over network 150, the theft prevention system 170 does not need to be remote from the store 160 in all situations. For example, if the store 160 is part of a relatively small store chain, then the theft prevention system 170 might be located in one of the retail stores. The theft prevention system 170 could also be a cloud function as well. In this case, the theft prevention system 170 might be located in a server rented from a cloud provider.

In view of the forgoing, various operations are performed at the theft prevention system 170 using the two sets of data, the real-time imaging data and tag/sensor data to the theft prevention system 170 prior to the person 114 getting to the checkout area 109 and the store entrance/exit 130. For example, the two sets of data are used to (1) increase the security and safety of the store 160 to prevent a person 114 even attempting theft, (2) track security tags paths of travel through the retail store, (3) generate a map indicating where one or more security tags are located within the store 160, and/or (4) collect and analyze information regarding behavioral patterns of thieves.

During store hours, a customer 114 may desire to purchase the article 118. The customer 114 can purchase the article 118 via a fixed POS station 102 (e.g., a checkout counter) or a mobile POS station (e.g., the customer’s mobile device). Once the article 118 has been successfully purchased, the theft prevention system 170 performs operations to cause the disablement and/or detachment of the security tag 122 from the article 118. In effect, an alarm is not issued when the customer passes through a security zone (not shown) which scans for tags or the like.

In some cases, a person may attempt to steal the article 118, and thus leave the store 160 with the article 118 having an activated security tag 122 coupled thereto or a maliciously deactivated secure tag 122 coupled thereto. When the person walks through the security zone at the store entrance/exit 130, an alarm may issue. However, the person 114 may not be stopped if a number of other people (e.g., 5) pass through the interrogation zone at the same or substantially the same time. Still, each time a person passes through the security zone a beacon of a proximity system 123 may cause a unique identifier of the tag 122 to be communicated to the theft prevention system 170. Additionally, the camera of the proximity system 123 is triggered to capture a time stamped image of the person and forward the same to the theft prevention system 170 for storage and analysis.

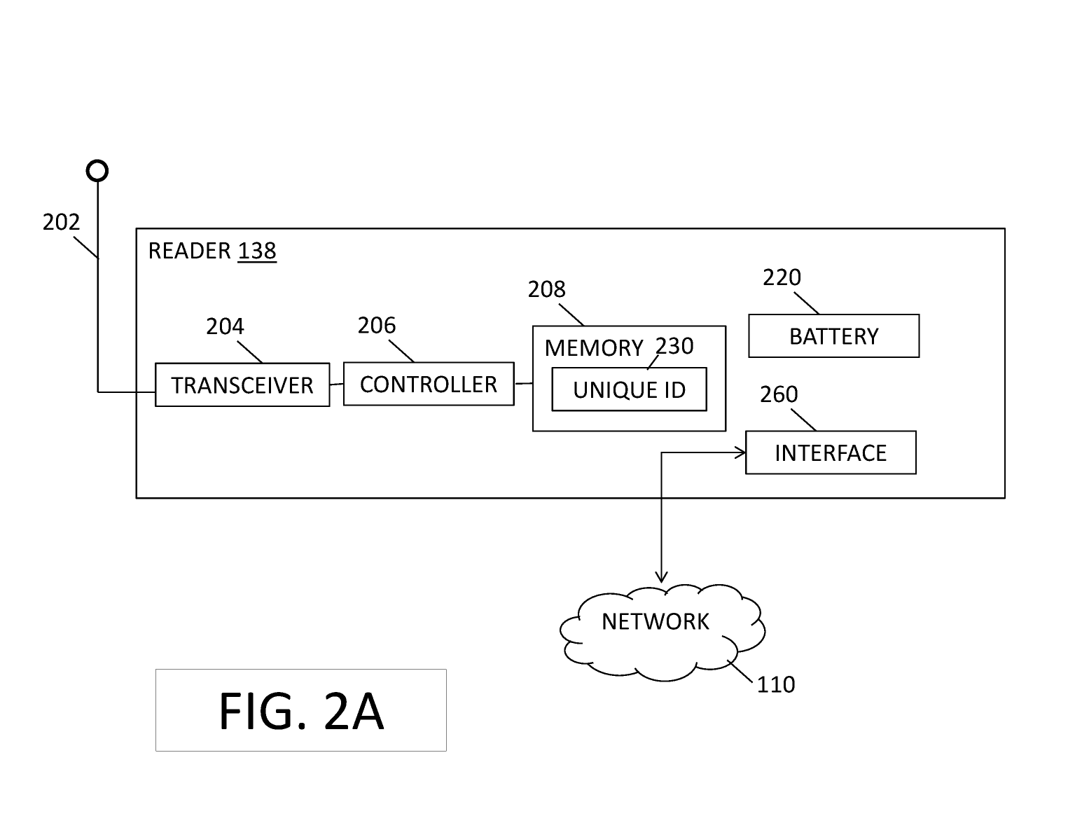

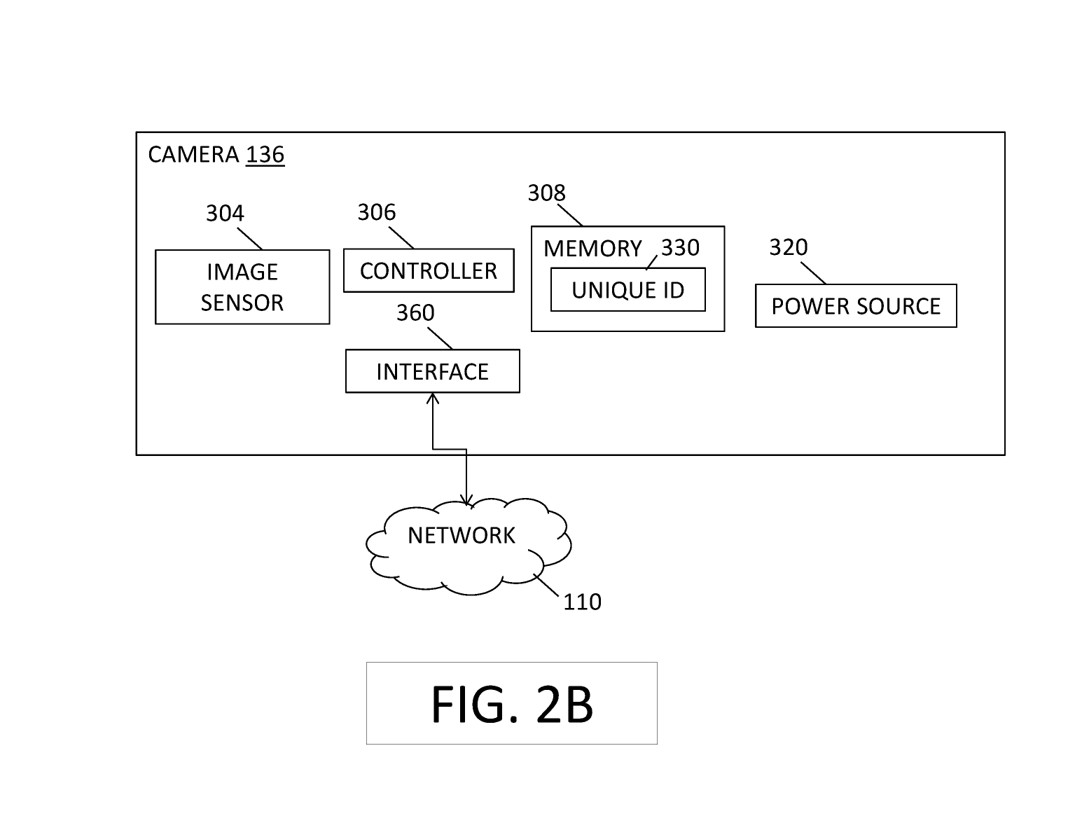

Referring now to FIG. 2A, there is provided a schematic illustration of an exemplary architecture for the reader 138 of FIG. 1. The reader 138 can include more or less components than that shown in FIG. 2A. However, the components shown are sufficient to disclose an illustrative embodiment implementing the present disclosure. Some or all of the components of the reader 138 can be implemented in hardware, software and/or a combination of hardware and software. The hardware includes, but is not limited to, one or more electronic circuits. The electronic circuit may comprise passive components (e.g., capacitors and resistors) and active components (e.g., processors) arranged and/or programmed to implement the methods disclosed herein.

The hardware architecture of FIG. 2A represents an embodiment of a representative reader 138 configured to facilitate improved store intelligence, store security, and data analytics. In this regard, the reader 138 is configured to exchange data with an external device (e.g., security tag 122 of FIG. 1) via short range communication (“SRC”) technology (e.g., Bluetooth, RF technology, etc.). The reader 138 may include components 204, 206, 208, 260 and a battery 220 shown in FIG. 2A but may include less or additional components.

The reader 138 includes an antenna 202 for allowing data to be exchanged with the external device via short range technology. The antenna 202 is configured to receive SRC signals from the external device and/or transmit SRC signals generated by the reader 138. The reader 138 comprises an SRC transceiver 204. It should be understood that the SRC transceiver 204 transmits SRC signals including first information to the external device, and processes received SRC signals to extract second information therefrom. The first information includes a unique identifier 230 of the reader 138. The unique identifier 230 provides a means for the theft prevention system 170 to determine the location of a person or security tag located within a given facility (e.g., store 160 of FIG. 1). The second information can include, but is not limited to, a unique identifier of an external device (e.g., security tag 122 of FIG. 1) and/or sensor data received from the external device (e.g., security tag 122 of FIG. 1). The transceiver 204 may pass the extracted second information to the controller 206.

At the controller 206, the information may be pre-processed to determine how the signal is to be handled by the reader 138. For example, the unique identifier of the external device and the unique identifier of the reader 138 may be forwarded to the theft prevention system 170 for security purposes.

Notably, the memory 208 may be a volatile memory and/or a non-volatile memory. For example, the memory 208 can include, but is not limited to, a Random Access Memory (“RAM”), a Dynamic Random Access Memory (“DRAM”), a Static Random Access Memory (“SRAM”), a Read-Only Memory (“ROM”) and a flash memory. The memory 208 may also comprise unsecure memory and/or secure memory. The phrase “unsecure memory”, as used herein, refers to memory configured to store data in a plain text form. The phrase “secure memory”, as used herein, refers to memory configured to store data in an encrypted form and/or memory having or being disposed in a secure or tamper-proof enclosure.

Data collected by the reader may then be passed to the theft prevention system 170 via interface 260.

Referring now to FIG. 2B, there is provided a block diagram of an exemplary architecture for the camera 136 that is useful for understanding the present disclosure. The camera 136 may include more or less components than those shown in FIG. 2B. However, the components shown are sufficient to disclose an illustrative embodiment implementing the present disclosure. Some or all of the components of the camera 136 can be implemented in hardware, software and/or a combination of hardware and software. The hardware includes, but is not limited to, one or more electronic circuits. The electronic circuit may comprise passive components (e.g., capacitors and resistors) and active components (e.g., processors) arranged and/or programmed to implement the methods disclosed herein.

The hardware architecture of FIG. 2B represents an embodiment of a representative camera 136 configured to facilitate improved store intelligence, store security, and data analytics. In this regard, the camera 136 is configured to capture images and/or video for processing by the theft prevention system 170. The camera 136 may include components 304, 306, 308, 360 and a power source 320 shown in FIG. 2B but may include less or additional components.

The camera 136 includes an image sensor 304 for capturing images/video using imaging technology. The images/video may be transmitted along with a unique identifier 330 of the camera 136. The unique identifier 330 provides a means for the theft prevention system 170 to determine the location of a person located within a given facility (e.g., RSF 160 of FIG. 1) because it is associated with the location of the camera 136.

At the controller 306, the information may be pre-processed to determine how the signal is to be handled by the camera 136. For example, certain movements may be detected by the camera 136 itself to alert the theft prevention system 170 and only such detected movements may be transmitted to the theft prevention system 170, in some embodiments.

Similar to FIG. 2A, the memory 308 may be a volatile memory and/or a non-volatile memory. For example, the memory 308 can include, but is not limited to, a RAM, a DRAM, a ROM and a flash memory. The memory 308 may also comprise unsecure memory and/or secure memory. The phrase “unsecure memory”, as used herein, refers to memory configured to store data in a plain text form. The phrase “secure memory”, as used herein, refers to memory configured to store data in an encrypted form and/or memory having or being disposed in a secure or tamper-proof enclosure.

Data collected by the camera 136 may then be passed to the theft prevention system 170 via interface 360 which transmits data to/from the network 110.

Referring now to FIG. 3, an exemplary theft prevention system 170 is shown. The theft prevention system 170 includes the computer/server 128. The computer/server 128 may include an interface 312, processor 314, memory 316, a module for determining potential theft (“theft determination module”) 318, a communication module 321, predefined theft movements 322, and predefined tag triggers 322.

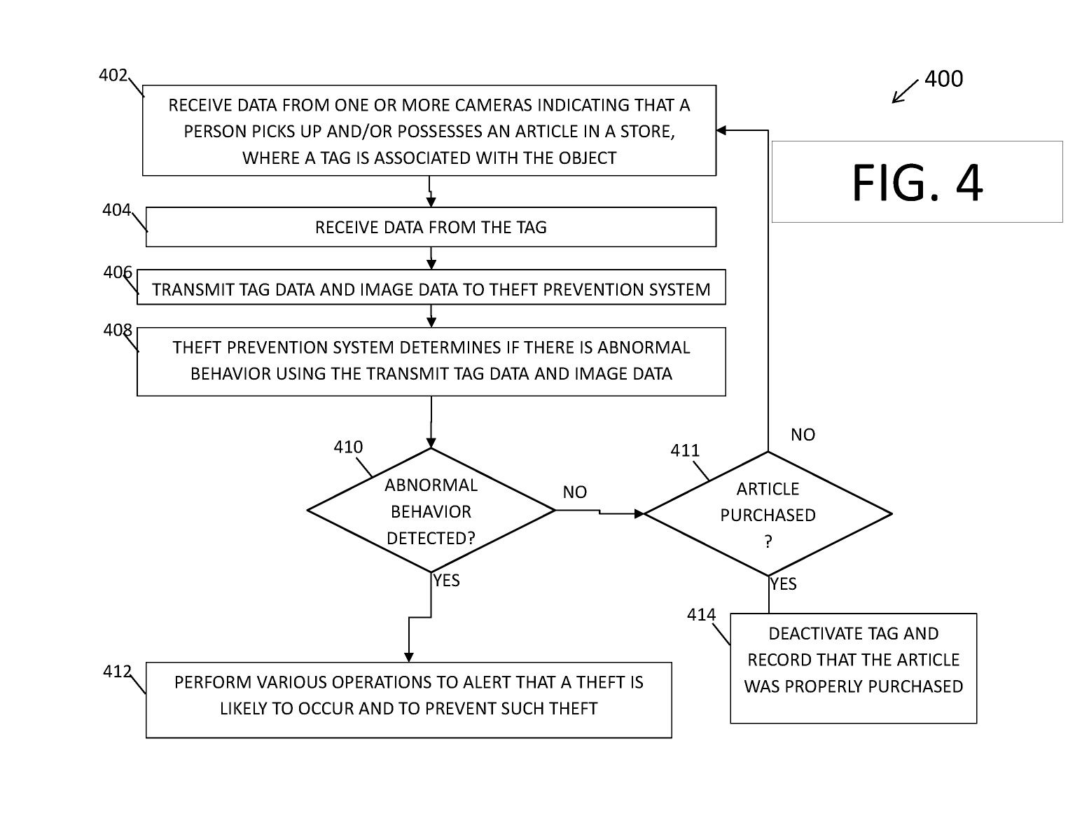

The processor 314 is configured to execute computer readable instructions stored in memory 316 to perform one or more method steps discussed in FIG. 4. For example, the processor 314 is configured to read and execute instructions from memory 316 for the theft determination module 158 to. Each of the steps discussed herein may be programmed for the theft prevention system 170 to perform the specific steps recited herein.

The communication module 321 and the theft determination module 318 software programs stored in memory in the computer/server 128 or may be stored over a network on a computer/server over a network remote from the store 160 or in database 142.

The communication module 321 is configured to communicate data between the systems (e.g., theft prevention system 170, database 140, POS devices 102, etc.) herein. For example, the communication module 321 is configured to connect the theft prevention system 170 with the PS systems 102 via the network 110 using network protocols to transmit data instructed by the processor 314.

The theft determination module 318 is configured to execute the steps of FIG. 4 to determine if a theft is in process or may be a high probability of occurrence in the future. The theft determination module 318 processes the data received by the cameras 136 and readers 138 and comparing such data with the predefined theft movements 322 and/or predefined tag triggers 322 to determine if a theft is likely.

The theft determination module 318 may be called by the processor 314 to execute one or more functions detailed in FIG. 4.

The predefined theft movements 322 are movements of a customer that are likely to be identified with theft. These predefined theft movements 322 may be known movements and could be updated using a learning model based on historical and current on-going data. Examples of such movement have been described herein above.

The predefined tag triggers 322 has also been described as examples herein above as events which likely will trigger the theft prevention system 170 to identify a theft action. For example, the triggers 322 relate to tampering with a tag 122 to remove or deactivate the tag.

In this regard, the theft determination module 318 uses the image and sensor/tag data along with the predefined theft movements 322 and/or predefined tag triggers 322 to determine if a theft is likely.

The predefined theft movements 322 and/or predefined tag triggers 322 are continually updated and may be done so on an ongoing basis using AI technology and/or learning models.

If the theft determination module 318 identifies a theft is likely to happen, it will transmit notifications and alerts to the store employees through audible, visual or other types of alerts. Additionally, the theft determination module 318 can notify the customer 114 directly so that the customer 114 can make an immediate decision and put the item 118 back or decide to pay for the item 118. In this regard, the customer 114 is not embarrassed in public or in front of store employees and there would be no damage to property or loss to store.

Because the system identifies the potential theft by the customer well before the customer reaches the checkout area, the system does not create a scene or drama at the store and is seamless to the customers, creating a better customer experience.

Referring now to FIG. 4, there is provided a flow diagram of an exemplary method 400 for providing store intelligence. The method 400 may be implemented in system 100 and concerns preventing the theft of an article (e.g., article 118 of FIG. 1) placed in a location within a facility (e.g., RSF 160 of FIG. 1) where a person has access thereto (e.g., on a shelf or other display equipment). The article has a security tag (e.g., security tag 122 of FIG. 1) attached thereto. The security tag 122 may be the same as that discussed above which may be an RFID tag that is configured to be read by a reader (e.g., reader 138 of FIG. 1).

The method 400 begins with block 402 where data from one or more cameras is received indicating that the person picks up the article in the store. In some embodiments, only the cameras within view of the article record image data.

In block 404, the data from the security tag 122 is received from the reader. The data read may be the tag ID and the operational status of the tag 122. However, it is noted that, in some embodiments, the tag 122 should not be limited to transmitting only the tag ID and operational status of the tag but can include other data. Indeed, the security tag may a plurality of sensors disposed therein, where the sensors can include, but are not limited to, proximity sensors, temperature sensors, accelerometers, liquid sensors, light sensors, magnetic field sensors, and/or location sensors. This sensor data may relate to the movement of the security tag, changes in light conditions of an environment surrounding the security tag, changes in the temperature of the surrounding environment, changes in an amount of fluid/liquid contain in the surrounding environment, and/or changes in a magnetic field generated by the security tag. As such, the tag 122 can transmit various other data associated therewith.

In any event, the tag data and the image data is transmitted to the theft prevention system 170 for processing, as provided in block 406. It should be noted that more than one reader can be reading the tag and transmitting tag data for processing. Similarly, it should be noted that more than one camera can be taking images of the person’s movements and transmitting image data for processing.

In some embodiments, block 404 can occur first and trigger block 402. Specifically, when the tag is determined to have been moved, data from the camera is then received to determine if the customer’s movement is abnormal behavior.

Next, in 406, a unique identifier of the security tag and/or a unique identifier of a reader 138 and camera 136 are communicated to the theft prevention system 170 along with tag and image data associated with movement of the tag and person, respectively. The reader's unique identifier and/or camera’s unique identifier are sent to specify the current location of the security tag and/or person associated therewith. The present disclosure is not limited to this technique of tracking the location of security tags. In other scenarios, other location determining techniques (e.g., triangulation) can additionally or alternatively be employed. The tag/sensor data, image data and/or unique identifiers can be sent to the theft prevention system 170 via a proximity system (e.g., proximity system 104, 106, 108, 110 or 112 of FIG. 1) or via an intermediary computing device.

At the theft prevention system 170, the tag/sensor data, image data and/or unique identifiers are processed in step 408 to determine if the security tag 122 has found its way into a circumstance of theft that is predictive in nature. Next a decision block 410 is performed to determine if there is abnormal behavior of the security tag or the person’s movement.

First, the system determines if the security tag has been moved. If the security tag is not being moved, then the system will look at the image data to determine if the person’s movement is abnormal (as discussed later herein). In contrast, if the security tag is being moved, then the theft prevention system 170 determines whether the security tag's movement is normal or abnormal. The decision may be based on a current orientation of a security tag, a velocity and direction of a security tag's movement (e.g., a relatively fast downward movement of the security tag may indicate a defeat attempt such as slamming the security tag on a hard surface), a pattern of the security tag's movement over a given period of time (e.g., rapid changes in the altitude of the article may indicate that the article is being held by a person running or walking relatively fast), and/or relative altitudes of different portions of the security tag (e.g., an altitude difference of the two ends of a security tag relative to a center portion of the security tag may indicate that a defeat attempt has occurred such as bending the security tag to deform the same). Pre-stored threshold values and/or sensor data patterns (e.g., accelerometer data patterns) can be employed in comparison operations to distinguish between normal movements and abnormal movements.

If the security tag's movement is determined to be abnormal, then the method continues to block 412 where the security tag's alarm is issued and other actions are performed to alert the store and/or the person 114 itself performing such abnormal actions. Additional action may also be performed including to: (1) cause an image to be captured of the person having possession of the article, (2) inform store personnel of the abnormal movement but transmitting an electronic message, outputting a specific sound on a speaker system, generating a visual alert, and the like, and/or (3) dispatch the store personnel to the area of the facility at which the person resides. Thereafter block 412, method 400 returns to block 402.

In contrast, if the security tag's movement is normal, then the method 400 determines if the persons movement is normal using cameras and image data. For example, the method 400 determines whether or not the security tag is being concealed, shielded or placed in a metal lined bag, as part of block 410. This determination can be made based on (1) sensor data specifying changes in light conditions and/or temperature conditions of an environment surrounding the security tag, and/or (2) sensor data indicating a detuning of the security tag.

If the security tag is being concealed/shielded/placed in a metal bag, then block 412 is performed as discussed above to alert the store and/or the person 114. In the case that the security tag's alarm is issued, the alarm's issuance may be ceased when the security tag has been removed from the concealing/shielding means or metal lined bag.

If the security tag is not being concealed/shielded/placed in a metal bag, then the system 170 determines whether or not the security tag is located in or traveling towards a high-risk location (e.g., an exit 130, checkout area 109, a bathroom, or a dressing room) indicating that a theft is more likely than not to be proceeding to the next step. If the security tag is located in or traveling towards the high-risk location, then block 412 is performed since it is determined that such actions are abnormal.

If the security tag 122 is not located in or traveling towards a high-risk location, then the system determines if an attempt is being made to defeat the security tag. For example, the security tag could be placed in liquid (e.g., water) or exposed to high temperatures to defeat the same. Accordingly, the determination can be made based on whether the tag data stops being transmitted because it is removed, deactivated, damaged or sensor data indicating a change in an amount of liquid of a surrounding environment and/or an increase in temperature of the surrounding environment.

The above relates to abnormal behavior using the tag/sensor data. If any of the above actions are detected, the system 170 may employ the image data from the cameras to supplement or be a part of the decision process as to whether the behavior is abnormal. In this regard, if the tag data indicates abnormal behavior of the tag, the system 170 may review the movements of the person 114 possessing the tag to determine if the person’s movement or actions are abnormal. As such, in some embodiments, only if both the tag data and the image data both indicate abnormal behavior does the system determine that overall abnormal behavior has occurred and the method 400 proceeds to block 412.

To determine if there is abnormal behavior using the camera data, the system 170 uses the image data to determine the movement of the person 114 as to whether such movement is abnormal. The extent of abnormal behavior, as discussed above, may include the person traveling to a high-risk location. In some embodiments, the extent of abnormal behavior may include watching arm movements of the person possessing the article 118. For example, the person placing the object in a concealed fashion, such as in their purse, in their jacket, in their bookbag, or the like instead of putting the item into the cart.

Another example could be the cameras monitoring the article and the image data noticing that the article 118 has moved but then the tag data identifying the tag associated with that article indicating that the tag 122 has not moved. As such, the image data and the tag data can then be combined together to form a system where together the data indicates that the tag has been removed from an item since the article is moving without the tag prior to being purchased which is a theft prevention triggering event in the selling area 105 of the store (i.e., before reaching the checkout area 109).

The cameras would capture this motion using the image data and process the images to determine that the user is concealing the item.

In some embodiments, the movements of the person may be compared with predetermined theft movements stored. If an item is determined to have been stolen, the movements of that person who stole the item can be analyzed and saved as predetermined theft movements for future use so that future movements of people in the store that match such predetermined theft movements will trigger the theft alarm. For example, if a person had stood at a shelf and grabbed an item and looked around to see if anyone was watching for 30 seconds, and then eventually stole the item, a future person making the same movements will trigger such a theft alarm.

Moreover, an artificial intelligence (AI) model can be fed the predetermined theft movements and learn these behaviors so that it is constantly being updated. As such, the predetermined theft movements are constantly being modified and understood based on changing behaviors and new behaviors as the thieves change their behaviors to try to outsmart the systems in the stores. In this regard, the predetermined theft movements are updated using AI learning models. Similarly, the AI learning models update the predefined tag triggers as well based on previous actions determined by the models to be theft activities and events.

Moreover, the AI models can be updates using other data from other stores. The AI models would compare the data for known thefts from both the security camera footage and the in store movement that is identified through the RFID tracking and update the models and data accordingly and immediately apply those new models to current algorithms in the stores to determine if a theft is likely to occur while in the selling area of the stores.

It should be understood that the AI models would identify the common behavior patterns of the thieves prior to entering the store and while moving through the store. And when a behavior pattern is identified in real time, the store security personnel would be alerted via a mobile device.

The article may or may not be purchased, rented or loaned by the person. If the article has not been successfully purchased, rented or loaned, then block 448 is performed where the method 400 returns to step 402 to continue monitoring the article, person, and/or tag. If the article has been successfully purchased, rented or loaned (as determined by block 411), then certain information is communicated from the system 170 to the security tag indicating a successful transaction. Thereafter, the security tag performs operation to deactivate itself and/or detach itself from the article, as shown in block 414.

Thus, the idea herein is to look at the pattern of movement within the selling area 105 of the store before the person gets to the checkout or before they attempt to exit the store. Indeed, as described above, the first step would be to learn the patterns of normal shoppers who are going to head to the checkout to purchase the product versus shoppers who will try to leave the store with the item without approaching the checkout area. Once pattern(s) of movement are identified that are likely to result in a theft, those patterns can be flagged and alerted to the security personnel who could handle it before they even get to the front of the store or near the checkout. The benefit would be 1) prevention can start much earlier in the journey rather and 2) dealing with the situation would not have to be in the hands of the sales attendant or cashiers.

In this regard, the present disclosure includes a model in that the reader 138 both tracks that a product has moved (to associate the before and after video with that specific, if it's ultimately stolen), and the RFID of the item moving off the shelf to trigger cameras to review/view of the before/after/during related to that article to inform the security system 170 to start watching its RFID patterns to determine if the article is being stolen or not. This can happen for all items being selected to be purchased and continues from the point of the person selecting the article until the article reaches the checkout area 109 but not when the item enters the checkout area 109.

In some embodiments, instead of issuing an alert to stop theft, the system 170 may ask the person via an electronic device if they wish to buy these items now or place the item in their cart so that it lets the person know that the store knows about the person attempting to steal the item or at least accidentally did an action to trigger the event so they person can correct such behavior prior to arriving at the checkout area 109.

Unless the context clearly requires otherwise, throughout the description and the claims, the words "comprise," "comprising," and the like are to be construed in an inclusive sense, as opposed to an exclusive or exhaustive sense; that is to say, in the sense of "including, but not limited to." As used herein, the terms "connected," "coupled," or any variant thereof, means any connection or coupling, either direct or indirect, between two or more elements; the coupling of connection between the elements can be physical, logical, or a combination thereof. Additionally, the words "herein," "above," "below," and words of similar import, when used in this application, shall refer to this application as a whole and not to any particular portions of this application. Where the context permits, words in the above Detailed Description using the singular or plural number may also include the plural or singular number respectively. The word "or," in reference to a list of two or more items, covers all of the following interpretations of the word: any of the items in the list, all of the items in the list, and any combination of the items in the list.

The above detailed description of embodiments of the present disclosure is not intended to be exhaustive or to limit the present disclosure to the precise form disclosed above. While specific embodiments of, and examples for, the present disclosure are described above for illustrative purposes, various equivalent modifications are possible within the scope of the present disclosure, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified to provide alternative or sub-combinations. Each of these processes or blocks may be implemented in a variety of different ways. Also, while processes or blocks are at times shown as being performed in series, these processes or blocks may instead be performed in parallel, or may be performed at different times. Further any specific numbers noted herein are only examples: alternative implementations may employ differing values or ranges.

The teachings of the present disclosure provided herein can be applied to other systems, not necessarily the system described above. The elements and acts of the various embodiments described above can be combined to provide further embodiments.

Any patents and applications and other references noted above, including any that may be listed in accompanying filing papers, are incorporated herein by reference. Aspects of the present disclosure can be modified, if necessary, to employ the systems, functions, and concepts of the various references described above to provide yet further embodiments of the present disclosure.

These and other changes can be made to the present disclosure in light of the above Detailed Description. While the above description describes certain embodiments of the present disclosure, and describes the best mode contemplated, no matter how detailed the above appears in text, the present disclosure can be practiced in many ways. Details of the system may vary considerably in its implementation details, while still being encompassed by the present disclosure disclosed herein. As noted above, particular terminology used when describing certain features or aspects of the present disclosure should not be taken to imply that the terminology is being redefined herein to be restricted to any specific characteristics, features, or aspects of the present disclosure with which that terminology is associated. In general, the terms used in the following claims should not be construed to limit the present disclosure to the specific embodiments disclosed in the specification, unless the above Detailed Description section explicitly defines such terms. Accordingly, the actual scope of the present disclosure encompasses not only the disclosed embodiments, but also all equivalent ways of practicing or implementing the present disclosure under the claims.

While certain aspects of the present disclosure are presented below in certain claim forms, the inventors contemplate the various aspects of the present disclosure in any number of claim forms. For example, while only one aspect of the present disclosure may be recited as a means-plus-function claim under 35 U.S.C sec. 112(f), other aspects may likewise be embodied as a means-plus-function claim, or in other forms, such as being embodied in a computer-readable medium. (Any claims intended to be treated under 35 U.S.C.§112(f) will begin with the words "means for".) Accordingly, the inventors reserve the right to add additional claims after filing the application to pursue such additional claim forms for other aspects of the present disclosure.

What is claimed is:

1. A method comprising:
receiving, from a camera, image data of a person selecting an article for sale in a selling area of a store and receiving, from a reader, tag data associated with the article, where a tag is associated with the article;
determining, by an electronic device remotely located from the article, that a potential theft event is likely to occur using both the tag data and the image data while the item is in the selling area of the store but before the item is proximate to a checkout area of the store;
selectively performing, by the electronic device, first operations facilitating facility security in response to determining that the article and tag is currently being manipulated in an abnormal manner.

2. The method according to claim 1, wherein the selectively performing is performed in response to determining that the article has been moved using the image data but the tag data indicates that the tag has not moved indicating that the tag has been removed or deactivated.

3. The method according to claim 1, further comprising determining that the tag has moved locations using the tag data, thereby indicating that the article has been selected, and then activating the camera to monitor the article to thereby determine if movements of the person in proximity to the article are abnormal.

4. The method of claim 1, wherein the selectively performing comprises selectively performing, by the electronic device, first operations facilitating facility security if a determination is made that the security tag is currently being moved in an abnormal manner.

5. The method of claim 1, wherein the selectively performing comprises selectively performing, by the electronic device, first operations facilitating facility security if a determination is made that the image data is currently being moved in an abnormal manner.

6. The method according to claim 1, further comprising providing pre-stored article-related information from the security tag to a mobile communication device if a determination is made that the security tag is not being moved in an abnormal manner or in response to reception of a query.

7. The method according to claim 1, wherein the first operations facilitating facility security comprise issuing an alarm of the security tag, causing an image to be captured of a person in possession of the security tag, notifying store personnel of the security tag's abnormal movement, or dispatching the store personnel to a location within a facility at which the security tag resides.

8. The method according to claim 1, further comprising:
analyzing, by the electronic device, the tag data or image data to determine if the security tag is being concealed or deactivated; and
selectively performing, by the electronic device, third operations facilitating facility security if a determination is made that the security tag is being concealed or deactivated.

9. The method according to claim 1, further comprising:
analyzing, by the electronic device, the tag data and image data to determine if the security tag is located in or traveling towards a high risk location of a facility; and
selectively performing, by the electronic device, fourth operations facilitating facility security if a determination is made that the security tag is located in or traveling towards a high risk location of a facility.

10. The method according to claim 1, further comprising using a learning model to constantly update predefined tag triggers and predetermined theft movements.

11. The method according to claim 10, further comprising comparing the tag data to the predefined tag triggers and comparing the image data to predetermined theft movements to determine a likelihood of a theft event.

12. A system comprising:
a camera in a selling area of a store;
a tag is associated with the article sale in the selling area of a store;
a processor configured for:
receiving, from the camera, image data of a person selecting the article and receiving, from a reader, tag data associated with the article;
determining that a potential theft event has occurred using both the tag data and the image data while the item is in the selling area of the store but before the item is proximate to a checkout area of the store;
selectively performing first operations facilitating facility security in response to determining that the article and tag is currently being manipulated in an abnormal manner.

13. The system of claim 12, wherein the selectively performing comprises selectively performing, by the electronic device, first operations facilitating facility security if a determination is made that the security tag is currently being moved in an abnormal manner.

14. The system of claim 12, wherein the selectively performing comprises selectively performing, by the electronic device, first operations facilitating facility security if a determination is made that the image data is currently being moved in an abnormal manner.

15. The system according to claim 12, wherein the process is further configured for providing pre-stored article-related information from the security tag to a mobile communication device if a determination is made that the security tag is not being moved in an abnormal manner or in response to reception of a query.

16. The system according to claim 12, wherein the first operations facilitating facility security comprise issuing an alarm of the security tag, causing an image to be captured of a person in possession of the security tag, notifying store personnel of the security tag's abnormal movement, or dispatching the store personnel to a location within a facility at which the security tag resides.

17. The system according to claim 12, wherein the process is further configured for:
analyzing, by the electronic device, the tag data or image data to determine if the security tag is being concealed or deactivated; and
selectively performing, by the electronic device, third operations facilitating facility security if a determination is made that the security tag is being concealed or deactivated.

18. The system according to claim 12, further comprising:
analyzing, by the electronic device, the tag data and image data to determine if the security tag is located in or traveling towards a high risk location of a facility; and
selectively performing, by the electronic device, fourth operations facilitating facility security if a determination is made that the security tag is located in or traveling towards a high-risk location of a facility.

19. The system according to claim 1, further comprising using a learning model to constantly update predefined tag triggers and predetermined theft movements.

20. A nontransitory computer readable medium that, when executed by a processor, performs a method comprising:
receiving, from the camera, image data of a person selecting the article and receiving, from a reader, tag data associated with the article;
determining that a potential theft event has occurred using both the tag data and the image data while the item is in the selling area of the store but before the item is proximate to a checkout area of the store;
selectively performing first operations facilitating facility security in response to determining that the article and tag is currently being manipulated in an abnormal manner.
